(19) United States
(12) Patent Application Publication
(10) Pub. No.: US 2004/0136371 A1
(43) Pub. Date: Jul. 15, 2004

(54) Distributed implementation of control protocols in routers and switches

(76) Inventors: Rajeev D. Muralidhar, Santa Clara, CA (US); Sanjay Bakshi, Beaverton, OR (US); Rajendra S. Yavatkar, Portland, OR (US); Suhail Ahmed, Beaverton, OR (US)

Correspondence Address: MARGER, JOHNSON & MCCOLLOM - INTEL, 1030 SW MORRISON ST., PORTLAND, OR, 97205, US

(21) Appl. No.: 10/713,238

(22) Filed: Nov. 13, 2003

Related U.S. Application Data
(63) Continuation-in-part of application No. 10/039,279, filed on Jan. 4, 2002.

(51) Int. Cl. H04L 12/28; H04L 12/56

(52) U.S. Cl. 370/389; 370/401

(57) ABSTRACT

A router uses a distributed implementation of a routing control protocol to route a packet between a plurality of computer networks. The router includes a control-plane having a control-plane processor to implement a central control portion of the control protocol and a plurality of forwarding-planes, each having a forwarding-plane processor, to implement an offload control portion of the control protocol. A back-plane connects the forwarding-planes to each other and to the control-plane. Together, these components route a packet based on the distributed implementation of the control protocol. The protocol may be a signaling protocol, such as RSVP-TE, or a routing protocol, such as OSPF.

This application is a continuation-in-part of U.S. patent application Ser. No. 10/039,279, filed Jan. 4, 2002 and claims priority thereto.

### TECHNICAL FIELD

This invention relates generally to routers and switches, and more particularly, to achieving a scalable and distributed implementation of a control protocol.

### BACKGROUND

Routers and switches, hereinafter refer to collectively as routers, route (that is, direct and control) the flow of data packets between computers. Routers direct and control the flow of packets based on various control protocols, such as Open Shortest Path First protocol (“OSPF”), Routing Information Protocol (“RIP”), Label Distribution Protocol (“LDP”), and Resource reSerVation Protocol (“RSVP”).

Typically, a router control protocol is responsible for generating routing tables, exchanging routing updates, establishing packet flow, determining multi-protocol label switching, and performing other routing control functions. Together, these control functions enable the router to direct and control the flow of packets between computers.

Routers also perform packet forwarding and processing functions. Packet forwarding and processing functions are distinct from control protocol functions. Packet forwarding and processing functions operate to process and prepare packets containing information to be sent between computers. Control functions, on the other hand, operate to direct and control the flow of these packets based on particular control protocols.

### DESCRIPTION OF DRAWINGS

FIG. 1 is a diagram of a network.

FIG. 2 is a block diagram of a router implementing a distributed control protocol.

FIG. 3 is a diagram depicting the flow of a control protocol for the distributed implementation of OSPF control protocol.

FIG. 4 is a flow diagram of a process for implementing the distribution.

FIG. 5 is a view of computer hardware used to implement the process of FIG. 4.

FIG. 6 shows a flowchart of an embodiment of a method to process RSVP-TE traffic.

FIG. 7 shows a flowchart of an embodiment of a method to initialize a control card in an interior gateway device.

FIG. 8 shows a flowchart of an embodiment of a method to initialize an offload card in an interior gateway device.

FIG. 9 shows a flowchart of an embodiment of a method to process OSPF traffic on an offload card.

FIG. 10 shows a flowchart of an embodiment of a method to process OSPF traffic on a control card.

### DETAILED DESCRIPTION

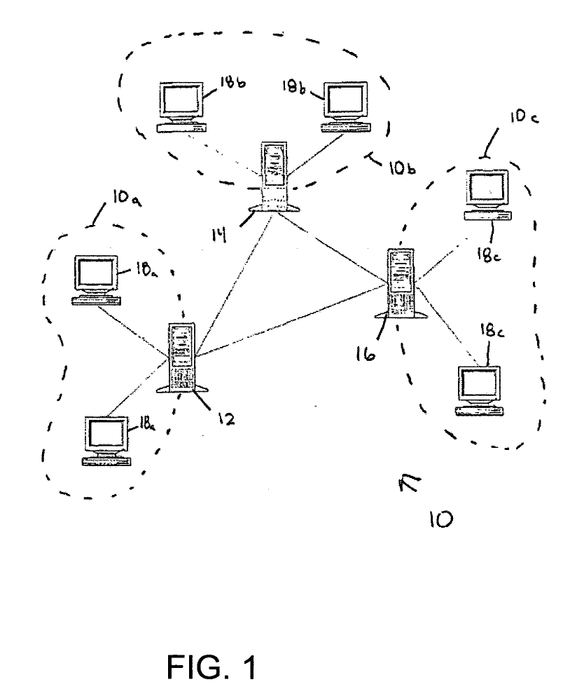

FIG. 1 shows a computer network 10 includes a plurality of computer networks 10a, 10b, and 10c connected to each other by routers 12, 14, and 16. Each computer network 10a, 10b, and 10c may have one or more computers 18a, 18b, and 18c.

Routers 12, 14, and 16 control and direct the flow of information in the form of packets (e.g., Internet Protocol packets) between computers in network 10. Routers 12, 14 and 16 control and direct the flow of each packet based on various control protocols, such as OSPF, RIP, LDP and RSVP.

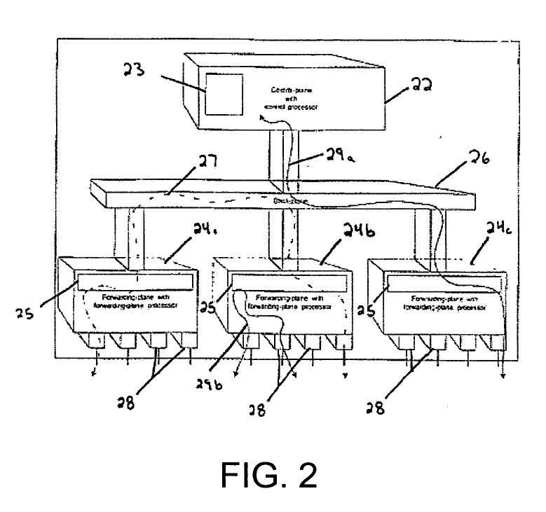

The following describe mechanism for distributing a control protocol for routers 12, 14 and 16 between control and forwarding planes. The control protocol is implemented by separating a control protocol into a central control portion implemented on a control-plane 22 (FIG. 2) and an off-load control portion implemented on a forwarding-plane 24. The present invention achieves a scalable, fault-tolerant implementation of a control protocol that may be scaled to handle hundreds of ports and/or interfaces. The present invention may also handle failure of central control plane software by allowing forwarding planes to continue to respond to control events and operate correctly during a recovery period. The embodiments described herein may be applied to all control protocols, e.g., control protocols, for implementing differentiated packet handling as necessary for quality of service, security, etc.

FIG. 2 shows the architecture of a router 20. Router 20 includes a control-plane 22 and one or more forwarding-planes 24. Control-plane 22 runs a control protocol and forwarding-planes 24 do packet processing.

In this regard, FIG. 2 shows a router 20 that implements a control protocol in a distributed manner. Router 20 has a control-plane 22, several forwarding-planes 24a, 24b and 24c, and a back-plane 26.

Control-plane 22 includes a control-plane processor 23, which may be a general-purpose processor. Control-plane processor 23 operates to implement the central control portion of the distributed control protocol.

Forwarding-planes 24a, 24b and 24c include a forwarding-plane processor 25 and a plurality of ports 28. Forwarding-plane processor 25 likewise may be a network processor, or a micro controller, a programmable logic array or an application specific integrated circuit. Forwarding plane processor 25 implements the off-load portion of the distributed control protocol. Here, the central portion and the off-load portion of the distributed control protocol are separated, in part, based on which operations the control-plane processor 23 and the forwarding-plane processor 25 may efficiently perform and based on where the necessary state information is located.

Ports 28, here physical ports, connect router 20 to network 10. In other embodiments, ports 28 may comprise both virtual and physical ports in which one or more physical ports may represent a plurality of virtual ports connecting router 20 to network 10 using various control protocols.

Back-plane 26 connects forwarding-planes 24a, 24b and 24c to each other and to control-plane 22. For example, back-plane 26 allows a packet received from network 10a (FIG. 1) at a port 28 on forwarding plane 24a to be routed to network 10b connected to a port 28 on forwarding-plane 24b (e.g., see flow arrow 27). Back-plane 26 also allows central control protocol information to be sent between control-plane 22 and network 10c through forwarding-plane 10c (e.g., see flow arrow 29a).

In other examples, back-plane 26 may be used to send information based on off-load portions of the control protocol between forwarding-planes 24a and 24c without being forwarded to control-plane 22 (e.g., see flow arrow 27). In still other examples, back-plane 26 need not be used to send information based on off-load portions of the control protocol. Rather, that information may be received by, and sent from, the same forwarding plane (i.e., see control flow arrow 29b).

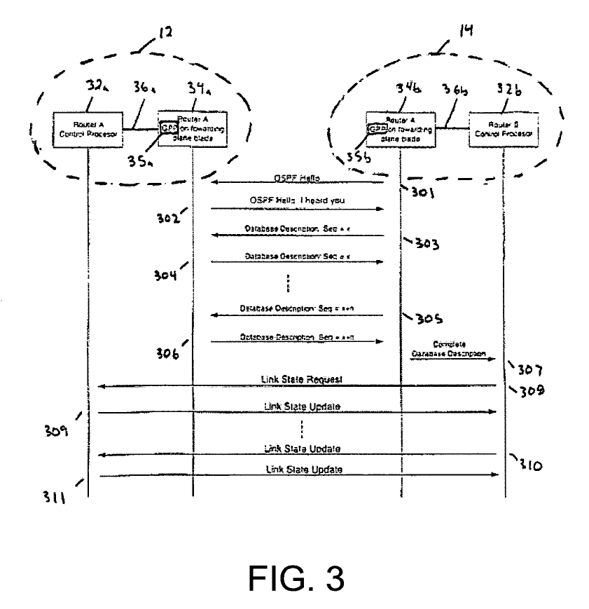

FIG. 3 shows routers 12 and 14 having control-planes 32a and 32b and forwarding-planes 34a and 34b for implementing a distributed control protocol (e.g., distributed OSPF). In this example, router 14 generates (301) an OSPF “HELLO” message at forwarding-plane 34b using an off-load portion of a distributed OSPF control protocol. Router 12, also using an off-load portion of the distributed OSPF control protocol, responds (302) to the HELLO message with an “I HEARD YOU” from forwarding-plane 34a. Router 14 now knows that router 12 is listening and requests (303) a “DATABASE DESCRIPTION” from router 12. Again, this request (303) is generated at forwarding-plane 34b using the off-loaded control portion of the distributed OSPF control protocol. Forwarding-plane 34a responds (304) using the off-load portion of the distributed OSPF control protocol with the appropriate “DATABASE DESCRIPTION” for router 12. This sequence of requests (303) and responses (304) continues until an n^{th} request (305) and response (306) for the DATABASE DESCRIPTION of router 12 has been received. Thereafter, the complete DATABASE DESCRIPTION for router 12 may be forwarded (307) from forwarding-plane 34b to control-plane 32b on back-plane 36b. Hence, the number of control flow transmissions between forwarding-plane 34a and control plane 32a over back-plane 36b is reduced (e.g., since the control information is transmitted only between forwarding-planes).

In this embodiment, it is the responsibility of control-planes 32a and 32b to keep the state in the offload portion current and correct. This implementation helps reduce processing on control-planes 32a and 32b, which becomes more significant as the number of ports and the number of control messages possessed by routers 12 and 14 increase.

At this point, control-processor 32b on router 14, using the central control portion of the distributed OSPF control protocol, requests (308) a LINK STATE REQUEST from router 12. In response, control processor 32a on router 12 also implementing the central control portion of the distributed OSPF control protocol responds (309) with a LINK STATE UPDATE. The central control portions of the distributed OSPF control protocols continue thereafter (310 and 311) as initiated by routers 12 and 14.

In the above example, the generation of OSPF HELLO messages may be off-loaded to the off-load portion of the distributed OSPF control protocol by several methods. For example, control-processor 32b may specify a message template, a frequency of message generation, and an outgoing interface to receive and send the message, to general-purpose processor 35b. Once specified, forwarding-plane 34b may generate the HELLO message at processor 35b until the control-plane 32b instructs otherwise. In other embodiments, an application specific integrated circuit may be used to generate the HELLO message.

Similarly, responding to the HELLO message may also be off-loaded to the off-load portion of the distributed OSPF control protocol. Together, the off-loading of the HELLO message generation and response reduces traffic across back-planes 36a and 36b and processing load on control planes 32a and 32b.

The HELLO protocols may be selected as an off-load portion of the distributed OSPF control protocol for several reasons. For example, OSPF control protocol requires the periodic exchange of HELLO messages to verify that links between routers 12 and 14 are operational and to elect a designated router and back up routers to route packets over network 10. As such, HELLO operations require significant and somewhat redundant overhead from a control processor implementing a traditional OSPF protocol. These types of control protocol operations are ideal for off-loading; especially for routers having hundreds of ports capable of receiving HELLO messages over a short duration, since the operations are relatively repetitive and the control-plane may watch over them with relatively little overhead.

Other OSPF protocols such as sending link state advertising requests (i.e., LSA requests) and rejecting erroneous LSA requests may also be off-loaded onto forwarding planes 34a and 34b for similar reasons. For example, the off-load portion of the distributed control protocol may include the filtering and dropping of flooded LSA requests when an identical LSA request has previously been received within a given time period (e.g., within one second of a prior LSA request). This may allow router 14 to send the link-state headers for each LSA stored in router 14 (e.g. in a database) to router 12 in a series of DATABASE DESCRIPTION packets from forwarding-plane 34b, as shown in FIG. 3. In such an example, one DATABASE DESCRIPTION packet may be outstanding at any time and router 14 may send the next DATABASE DESCRIPTION packet after the previous packet is acknowledged though receipt of a properly sequenced DATABASE DESCRIPTION packet from router 12.

In this example, the off-load control protocol may be implemented by keeping a copy of the link-state headers, which are also stored on the control planes 32a and 32b, on forwarding-plane 34b. These copies of the link-state headers enable their exchange to be completely off-loaded from the control-planes 32a and 32b to forwarding planes 34a and 34b. The control plane processor 33a may then only step in after all the link-state headers have been exchanged to receive (307) the complete data description or to update the copy of the link-state headers stored on the forwarding planes. This complete data description, here LSA information, may be used as needed by router 14.

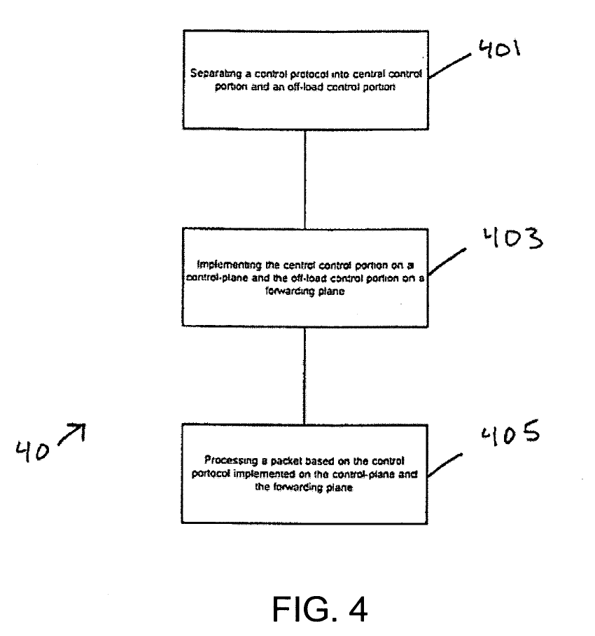

FIG. 4 shows process 40 for implementing a distributed control protocol on a router. Process 40 separates (401) a router control protocol (e.g., OSPF, RIP, LDP, or RSVP) into a central control protocol and an off-load portion. Process 40 separates (401) the router control protocol based upon, for example, which operations in the protocol are most efficiently performed by forwarding-planes 24a, 24b and 24c and which operations may be most efficiently performed on control-plane 22. Other factors in separating (401) may also be considered, such as the capability of the router to perform particular operations at the control-plane 22 and the forwarding-planes 24a, 24b and 24c. This separation (401) may also be completed prior to installation on a router 20 or at router 20 based on the particular resources of that router.

Process 40 implements (403) the central control portion of the distributed control protocol on a control-plane 22 and the off-load control portion on the forwarding planes 24a, 24b and/or 24c to process (405) a control packet according to the control protocol. In other words, process 40 may process a control packet without that packet knowing a distributed process is being implemented.

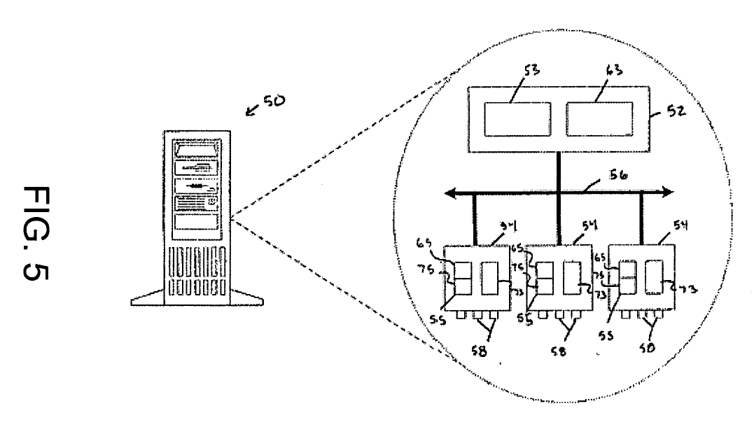

FIG. 5 shows a router 50 for implementing a distributed control protocol. Router 50 includes a control-plane 52, several forwarding-planes 54 and a back-plane 56.

Control-plane 52 includes a control processor 53 and a storage medium 63 (e.g., a hard disk). Processor 53 implements the central control portion of the distributed control protocol based on information stored in storage medium 63. Forwarding-plane 54 includes a forwarding processor 55, here a network processor combining a general purpose RISC processor 65 (e.g., a Reduced Instruction Set Computer) with a set of specialized packet processing engines 75, a storage medium 73, and a plurality of ports 58. Here, general-purpose processor 65 performs the off-load portion of the distributed control protocol and the packet processing engines 75 perform packet forwarding and processing functions. Storage medium 73 (e.g., a 32 megabyte static random access memory and a 512 megabyte synchronous dynamic access memory) cache and store information necessary to complete the off-load portions of the distributed router control protocol. In other embodiments, an application specific integrated circuit may be used to implement a portion of the distributed control protocol.

The distributed control protocol may be implemented in computer programs executing on programmable computers or other machines that each includes a network processor and a storage medium readable by the processor.

Each such program may be implemented in a high level procedural or object-oriented programming language to communicate with a computer system. However, the programs can be implemented in assembly or machine language. The language may be a compiled or an interpreted language.

Each computer program may be stored on an article of manufacture, such as a CD-ROM, hard disk, or magnetic diskette, that is readable by router 50 to direct and control data packets in the manner described above. The distributed control protocol may also be implemented as a machine-readable storage medium, configured with one or more computer programs, where, upon execution, instructions in the computer program(s) cause the network processor to operate as described above.

A number of embodiments of the invention have been described. Nevertheless, it will be understood that various modifications may be made without departing from the spirit and scope of the invention. For example, other router control protocols may be separated into distributed router control protocols. In particular, the generation of PATH and RESV refresh messages in RSVP control protocol may be selected as an off-load portion. Here, the central control portion may provide state information (e.g., a copy of the refresh state received from a particular next or previous hop) so that the forwarding plane may process some of the incoming refresh messages. Also the HELLO processing of Label Distribution Protocol (“LDP”) and Constrained based LDP (“CD-LDP”) may be fully offloaded in a manner as explained above. The same distribution may also apply to Intra-Domain Intermediate System to Intermediate System Routing Protocol (“IS-IS”) by offloading its HELLO processing onto a forwarding-plane.

In another embodiment, more of the processing for these and other similar protocols may also be offloaded. Further offloads for the RSVP-TE or other interior gateway signaling protocols may involve the processor 53 being configured and arranged to execute a control portion of the protocol. The store 63 on the control plane or card 52 would store a table of label switched paths. The line processor 55 would have a general-purpose processor 65 and the microengine 75, the combination of which may be referred to as a network-enabled processor. Examples of a control processor may include Intel®Architecture (IA) processors, and examples of network-enabled processors may include Intel® IXP processors. In the context of RSVP-TE, the microengine 75 or the line processor 65 may also provide a timer to allow session timing as is discussed below.

An interior gateway is one within an autonomous system. An autonomous system is defined by a network under a single administrative control, such as AT&T Worldnet, UUNET, etc. A signaling protocol, such as RSVP-TE does not perform routing; it depends upon some link state routing protocol like OSPF and OSPF-TE to be already running between nodes of the network. Signaling protocols such as RSVP pass signals from end to end across a circuit, or from device to device to make reservations for pathways, notify devices in the network of other devices being down, etc.

Many protocols use labels of some type or another to identify paths and circuits in the network. The advent of Multi-Protocol Label Switching has moved the protocol-specific labels out and allowed the establishment of Label Switch Paths (LSPs) in the network. RSVP-TE relies upon flow definitions to make the necessary resource reservation requests. Combining RSVP-TE with MPLS has allowed the definition of a flow to become more flexible. The RSVP flow would now be defined as a set of packets having the same label value assigned by a particular node. Labels being associated with a traffic flow make it possible for a network device to identify the appropriate reservation state for a packet based upon its label value.

Problems can arise when routers and other network devices have to support thousands or tens of thousands of LSPs. The signaling protocols such as RSVP-TE require many messages, parameter exchanges, and procedures. These in turn require complex state maintenance. This impedes scalability of the network and the use of quality of service (QoS) protocols like RSVP-TE.

The ability to offload some of these functions to line cards, with line processors, such as shown in FIG. 5 would be an advantage. For example, RSVP-TE devices maintain an Incoming Interface Path State Block (PSB) and a Resv State Block (RSB) and an Outgoing Interface PSB and RSB. These all have to maintain a session timer, which determines the frequency at which the PATH and RESV refresh messages are sent out to peers to maintain connectivity. This is another example of a function that can be offloaded to the line cards.

In signaling protocols such as RSVP, PATH messages must be delivered end-to-end. This can be problematic in that RSVP does not have good message delivery mechanisms. For example, if a message is lost in transmission, the next re-transmit cycle by the network could be one soft-state refresh interval later, typically 30 seconds. This is a relatively long time in a high-speed network. To overcome this, a staged refresh timer may retransmit RSVP messages until the receiving node acknowledges. While this addresses the reliability problem, it introduces more complexities on per-session timer maintenance, message retransmission and message sequencing. This would be another example of a function that can be offloaded to the line cards.

One concern that arises when discussing offloading of functions to other processors is coordination and communication between the distributed portions of the signaling protocol. Both the signaling protocols and the routing protocols, discussed later, assume that there is some software architecture that manages the distribution. One example is the Distributed Control Plane Architecture for Network Elements discussed in co-pending U.S. patent application Ser. No. ______, filed Nov. 13, 2003. While this is one example of such architecture, it provides the functions of peer plug-in discovery, connection establishment, connection maintenance and message passing that allows the control card and any involved line cards to maintain the distribution.

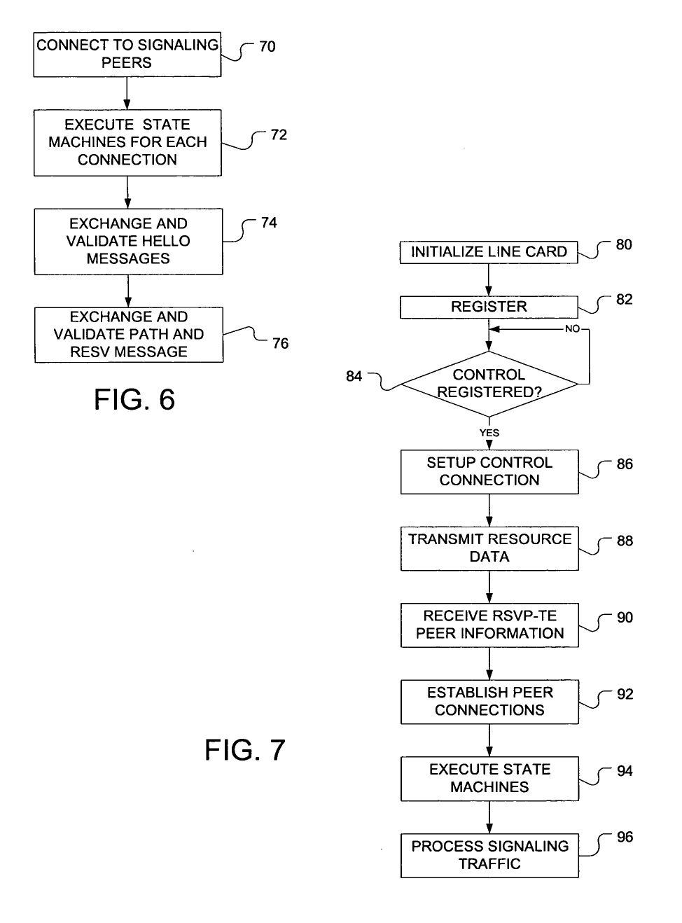

Having a distributed architecture as shown in FIG. 5, as well as a mechanism to coordinate and maintain the distribution makes distribution of an interior gateway signaling protocol possible. An embodiment of a method of distributing such a protocol is shown in FIG. 6. At 70, the line card would receive peer information from the control card as to configured RSPV-TE peers, those peers that are RSVP-TE enabled. The control card may also provide incoming and outgoing interfaces for each LSP being supported by the network device, and session timeout values for each LSP. The line cards would then establish the connections with these peers.

Once the connections with the peers would be established, at least one state machine for each connection is executed at 72. As discussed above, there would be four state machines and associated timers for each connection in RSVP-TE. At 74 and 76, signaling messages are exchanged with peers and validated. At 74, the HELLO messages from peers are exchanged and validated. If a peer goes off-line, the line card would notify the control card of the change in the connection. At 76, the PATH and RESV messages for setting up resource reservations would be exchanged and validated.

In order for this type of process to remain coordinated, the communication and connection between the line card and the control card should be initialized and maintained with that in mind. An embodiment of a method to establishing an offload portion of a signaling protocol is shown in FIG. 7.

In FIG. 7, the line card is initialized at 80. The offload portion of the protocol registers with a central registration point at 82, possible provided by the Distributed Control Plane Architecture (DCPA) discussed above. The central registration point may be what is referred to as the DCPA Infrastructure Module (DIM). Once the control card registers at 84, a control connection is set up between the two cards at 86. The line card then transmits its resource data such as its processing capabilities, physical resources it controls and interfaces that reside on it at 88. The control card configures the line card at 90 by providing the RSVP-TE peer information as well as the other information as mentioned above.

Upon reception of that data, the line cards establish peer connections with the RSVP-TE or other signaling protocol peers at 92. A state machine is executed for each connection at 94. At this point the line card is capable of processing signaling protocol traffic as discussed above at 96. The line card and the control card may only need to communicate when there is a failure or a signaling connection change.

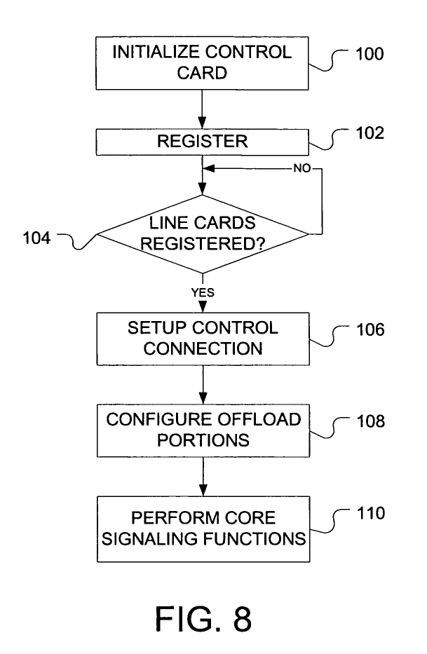

Similarly, the control card may be initialized by a process such as the embodiment shown in FIG. 8. The control card is initialized at 100 and registers with some central registration point at 102. Once the line cards are registered at 104, the control connection is set up between the control card and the line card or cards at 106. The offload portions of the signaling protocol are configured as discussed above at 108. The control card then performs core signaling functions. These may include admission control for the LSPs and the signaling paths, user interaction with the network administrators, and assigning QoS parameters for each path to conform to Service Level Agreements made by the network provider.

In this manner, signaling protocols may have several function offloaded to them. This enables the network to scale and still maintain control of the QoS parameters needed by its customers. Similar to the offloading of the more complex portions of signaling protocols, such as RSVP, it is possible to offload portions of OSPF beyond the HELLO offloading discussed above.

OSPF is an internal or interior gateway routing protocol, meaning that it is used internally to an autonomous system to distribute routing information. It relies upon link state technology. OSPF devices generally perform 3 functions. First they monitor connectivity with all other directly connected OSPF devices. This is done by the HELLO protocol discussed above.

Second, each OSPF device maintains a complete and latest topology of all of the OSPF routers within an autonomous system in a database called Link State Database (LSDB). Using a reliable flooding procedure, each OSPF device maintains an identical copy of the LSDB that contains each device's view of the network, such as the device's enabled interfaces and neighboring OSPF routers. Each device generates information about its view of the network via a Link State Advertisement (LSA). These are then flooded through the autonomous system by the other OSPF devices.

Third, the OSPF devices execute the shortest path first (SPF) algorithm on the LSDB whenever there is a change in the network. For example, a new OSPF device comes on line, or an interface on an existing device is disabled or fails. The algorithm calculates the shortest path through the autonomous system to destinations both inside and outside of it.

All of these functions directly impact the amount of time it takes OSPF to converge, which is the time it takes for all of the OSPF devices to converge to the same shortest path for all destinations. The speed at which the functions are accomplished determines how fast the LSDBs for each device are synchronized. Synchronization occurs through each device capturing information about its links in one or more Link State Advertisements (LSAs). The LSAs are distributed throughout the autonomous system via Link State Update packets (LSUs) and each OSPF device floods each received LSA to all other neighboring OSPF devices. To make this flooding procedure reliable, each LSA is acknowledged separately. Separate acknowledgements may be grouped together into a single LSU packet. All of these procedures may be very compute and memory intensive.

When faults are occurring in the autonomous system, the computational load on the control processor may increase significantly due to flooded packets from neighbors. The control processor may lag behind and miss certain crucial events related to the OSPF processing, such as delayed or missed LSAs. This causes neighboring routers to resend LSAs, further increasing the load on the control processor. One method to avoid or mitigate control processor overload was to introduce wait timers that ensure that OSPF processing can be serialized and delayed. This leads to delayed convergence, however, and may result in packets being lost or incorrectly routed for extended periods.

Returning to FIG. 5, the control processor 53 would be configured and arranged to execute a control portion of a link-state routing protocol. The store 63 would store the LSDB, particularly a control version of the LSDB, as will be discussed further. The line card 54 would have the line processor 55, and the store 73 would store a local version of the LSDB, also referred to as a ‘slim’ version in that it does not contain the depth of information as the control version of the LSDB.

As discussed above the control portion and the offload portion of the link-state routing protocol may require some mechanism to allow the two entities to stay coordinated and communicate between themselves. The offload of the OSPF functions may utilize the DCPA mentioned earlier, as well as other architectures.

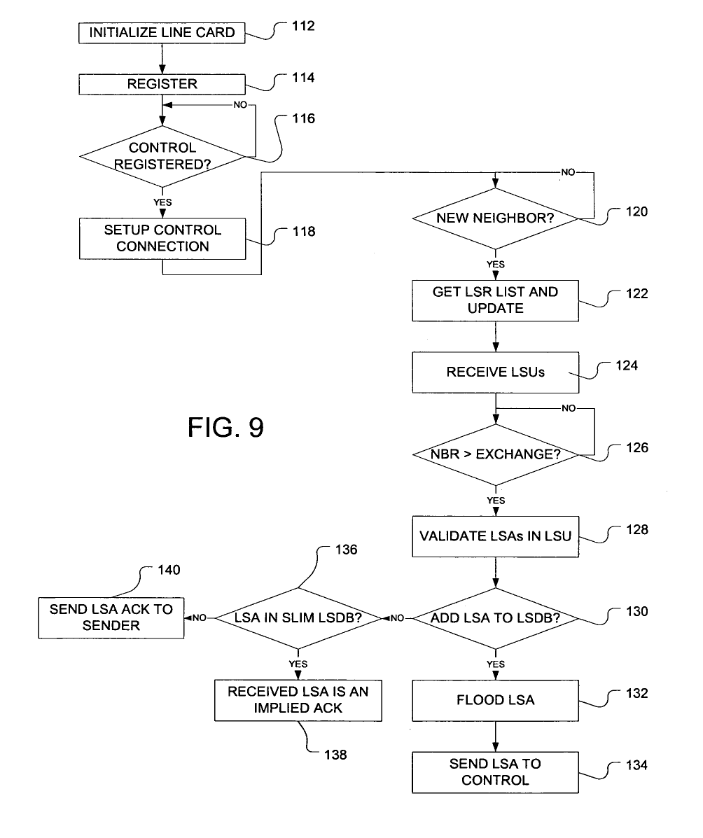

The functioning of the offload portion of the routing protocol is discussed with regard to FIG. 9. The line card is initialized at 112, registers with a central registration point at 114 and then determines if the control card is registered at 116. The control connection is setup at 118. Once the control connection is in place, the line card discovers any new neighboring devices of the same link-state routing protocol, such as OSPF. If there is a new neighbor, a link state request (LSR) list is obtained from the neighbor at 122, which is available as soon as two-way communication is established between the two devices. The state of the neighboring device may need to be determined, such as starting exchange (ExStart), exchanging (Exchanging) information, or full. Generally, the line card will be informed of this list by the control card. Both portions of the protocol need to maintain this list until the neighbor becomes ‘fully adjacent’. Fully adjacent means that the two devices have synchronized LSDBs. This may also be referred as reaching the full state, full referring to full adjacency.

The line card can now receive LSU packets at 124. The neighbor is determined to be in a state greater than Exchange, or not, at 126. If the neighbor has reached the exchange state at 126, the LSAs within the LSU are validated. Validation may take the form of checksum verification, LSA type verification, etc. At 130, the line card determines if the LSA is to be added to the LSDB. As mentioned above, there are two versions of the LSDB. The line card has a local, or ‘slim’, version of the LSDB that contains just the LSA headers. The received LSA is compared against the “slim” LSDB and the LSR list to determine if the LSA is to be added to the LSDB. If it is to be added to the LSDB, the device floods the LSA, sends an LSA acknowledgement back to the sender and updates the “slim” LSDB with the received LSA header information at 132. Thereafter it sends the LSA to the control card to allow the control card to update the control version of the LSDB at 134. The control card instantly adds the LSA to the control version of the LSDB.

If the LSA is not to be added to the LSDB, it may be because an entry already exists in the “slim” LSDB for that LSA, determined at 136. If there is already an entry, it typically means that the LSA was previously sent and may be in the LSRT; the LSA received from the sender is processed as an implied acknowledgement for an LSA originating from the line card and the LSA is removed from the LSRT at 138. If the LSA is not in the LSDB an acknowledgement (ACK) is sent to the sender at 140.

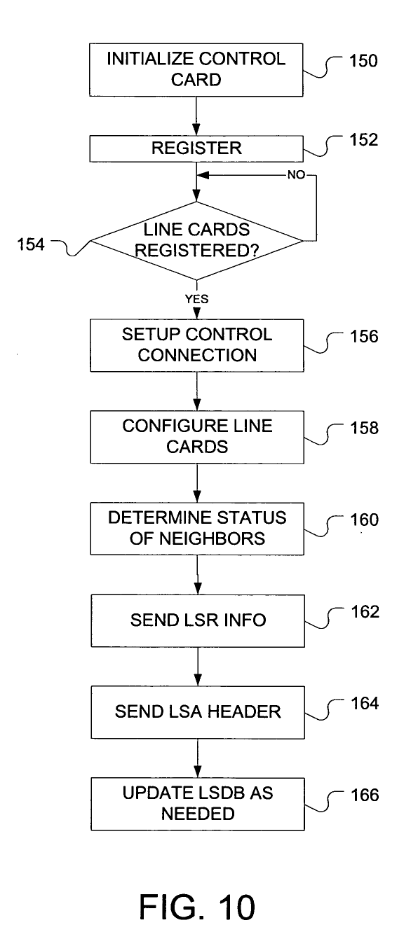

Having seen the offload portion, it is helpful to discuss the control portion of the link-state routing protocol. The control card undergoes the similar initialization, registration and waiting for line card registration at 150, 152 and 154 in FIG. 10. The control connection between the control card and any lines cards is established at 156 and the line cards are configured at 158. Configuration may take the form of setting up the slim version of the LSDB on the line card.

The control card may determine the status of neighboring devices at 160, as this will affect the information transmitted between the control card and the line cards. For example, for neighbors that are exchanging information and are not yet fully adjacent, the LSR for that neighbor may be transmitted at 162. Neighbors in this state will be referred to as ‘selected’ neighbors. When a neighbor achieves the full state, the LSA header information for that neighbor is sent to the offload portion to update the slim version of the LSDB. The control card will also add an LSAs received from the line card to the LSDB as soon as they are received. The exchange of these LSA is enabled by the backplane of the device, which may be a physical backplane or a virtual backplane or switching fabric.

In this manner, portions of link-state routing protocols such as OSPF can be offloaded from a central processor on a control card. This makes the device more robust and more responsive. The faster the device can respond, the faster the link-state routing protocol will converge across the autonomous system. The change of missing or not sending LSAs is greatly reduced, reducing the chance of LSU retransmissions. Generation of router LSAs may be handled by the OSPF offload. A router LSA describes the collected states of the router's link to an area.

Accordingly, other embodiments are within the scope of the following claims.

What is claimed is:

1. A system, comprising:
a control card, comprising:
a control processor configured and arranged to execute a control portion of an interior gateway signaling protocol; and
a table of label switched paths;
a line card, comprising:
a line processor configured and arranged to execute an offload portion of an interior gateway signaling protocol; and
at least one timer associated with each label switched path; and
a backplane to allow the control card and the line card to communicate.

2. The network device of claim 1, the control processor further comprising a general-purpose processor.

3. The network device of claim 1, the control processor further comprising an Intel Architecture processor.

4. The network device of claim 1, the line processor further comprising a network-enabled processor.

5. The network device of claim 1, the line processor further comprising an Intel IXP processor.

6. The network device of claim 1, the backplane further comprising a physical backplane connection.

7. The network device of claim 1, the backplane further comprising a network.

8. A method of handling an interior gateway signaling protocol, comprising:
establishing connections with peer devices;
executing at least one state machine for each connection established;
exchanging and validating signaling protocol messages with peer devices; and
communicating with a control card if there is a failure or a connection status change.

9. The method of claim 8, the method comprising receiving configuration information from a control card.

10. The method of claim 9, receiving configuration information from a control card further comprising receiving RSVP-TE configured peers, incoming and outgoing interface for each label switched path, and session timeout values for each label switched path.

11. The method of claim 8, exchanging and validating signaling protocol messages further comprising exchanging and validating RSVP-TE HELLO messages.

12. The method of claim 8, exchanging and validating signaling protocol messages further comprising exchanging and validating RSVP PATH messages.

13. The method of claim 8, exchanging and validating signaling protocol messages further comprising exchanging and validating RSVP RESV messages.

14. A method of establishing an offload portion of a distributed exterior gateway protocol, comprising:
initializing a line card;
registering an offload portion of a protocol to be executed by the line-card with a central registration point;
setup a control connection with a control card;
transmit data resource data to the control card;
receiving configuration information from the control card;
establishing signaling connections with interior gateway peers;
performing signaling protocol functions at the line-card; and
communicating with the control card during failures or signaling connection changes.

15. The method of claim 14, registering an offload portion further comprising registering with a distributed control plane architecture infrastructure module.

16. The method of claim 14, performing signaling protocol functions further comprising exchanging and validating RSVP-TE messages.

17. The method of claim 14, performing signaling protocol functions further comprising executing at least one state machine for each signaling connection.

18. A method of establishing a control portion of a distributed exterior gateway protocol, comprising:
initializing a control card;
registering a control portion of a protocol to be executed by the control card with a central registration point;
setting up control connections with line-cards executing offload portions of the protocol;
configuring the line cards by providing information with regard to signaling peers, link switched paths, and link switched path timeout periods; and
performing core signaling protocol functions.

19. The method of claim 18, registering a control portion of a protocol to be executed further comprising registering the control portion with a distributed control plane architecture infrastructure module.

20. The method of claim 18, performing central signaling protocol functions further comprising controlling admission to the signaling connections

21. The method of claim 18, performing central signaling protocol functions further comprising setting quality of service parameters.

22. An article of machine-readable code containing instructions that, when executed, cause the machine to:
establish connections with peer devices;
execute at least one state machine for each connection established;
exchange and validate signaling protocol messages with peer devices; and
communicate with a control card if there is a failure or a connection status change.

23. The article of claim 22, the instructions causing the machine to exchange and validate signaling protocol messages with a peer device further causing the machine to exchange and validate RSVP-TE HELLO messages.

24. The article of claim 22, the instructions causing the machine to exchange and validate signaling protocol messages with a peer device further causing the machine to exchange and validate RSVP-TE PATH messages.

25. The article of claim 22, the instructions causing the machine to exchange and validate signaling protocol messages with a peer device further causing the machine to exchange and validate RSVP-TE RESV messages.

26. A system, comprising:
a control card, comprising:
a control processor configured and arranged to execute a control portion of a routing protocol; and
a control version of a link state database;
a line card, comprising:
a line processor configured and arranged to execute an offload portion of a routing protocol; and
a local version of a link state database; and
a backplane to allow the control card and the line card to communicate.

27. The network device of claim 26, the control processor further comprising a general-purpose processor.

28. The network device of claim 26, the control processor further comprising an Intel Architecture processor.

29. The network device of claim 26, the line processor further comprising a network-enabled processor.

30. The network device of claim 26, the line processor further comprising an Intel IXP processor.

31. The network device of claim 26, the backplane further comprising a physical backplane connection.

32. The network device of claim 26, the backplane further comprising a network.

33. A method of distributing a routing protocol, comprising:
discovering a new neighboring device;
receiving a link state update from the new neighboring device;
verifying validity of link state advertisements in the link state update;
determining if the link state advertisements are to be added to a link state database;
if the link state advertisement is to be added to the link state database updating a local version of the link state database and communicating link state advertisement to a central version of the link state database on a control card.

34. The method of claim 33, the method further comprising determining the state of the new neighbor device.

35. The method of claim 33, the method further comprising generating link state acknowledgements.

36. The method of claim 33, the method further comprising generating router link state advertisements.

37. The method of claim 33, the method further comprising receiving the link state advertisement at the control card and instantly adding the link state advertisement to the control version of the link state database.

38. The method of claim 33, the method further comprising obtaining a link state retransmission list for the new neighbor device.

39. The method of claim 33, the method comprising determining that the link state advertisement has an entry in the local version of the link state database and removing the link state advertisement from the link state retransmission list.

40. The method of claim 33, the method comprising determining that the link state advertisement does not have an entry in the local version of the link state database and sending a link state acknowledgement.

41. A method of establishing a control portion of a routing protocol, comprising:
setting up a control connection with at least one line card;
configuring the link card with a local version of a link state database;
determining status of neighboring devices;
sending a link state request list for selected neighbors to the line card;
sending a link state advertisement header to the line card; and
adding any link state advertisements to a control version of the link state database when received from the line card.

42. The method of claim 41, setting up a control connection with at least one line card further comprising:
initializing the control card;
registering the control card with a central registration module;
determining if line cards have registered with the central registration module.

43. The method of claim 41, sending a link state request list for selected neighbors further comprising sending a link state request list for any neighbor that is exchanging information but is not yet fully adjacent.

44. An article of machine-readable media containing instructions that, when executed, cause the machine to:
discover a new neighboring device;
receive a link state update from the new neighboring device;
verify validity of link state advertisements in the link state update;
determine if the link state advertisements are to be added to a link state database;
if the link state advertisement is to be added to the link state database, update a local version of the link state database and communicate the update to a central version of the link state database on a control card.

45. The article of claim 44, the instructions further causing the machine to determine the state of the new neighbor device.

46. The article of claim 44, the instructions further causing the machine to obtain a link state retransmission list for the new neighbor device.

47. The article of claim 44, the instructions further causing the machine to determine that the link state advertisement has an entry in the local version of the link state database and removing the link state advertisement from the link state retransmission list.

48. The article of claim 44, the instructions further causing the machine to determine that the link state advertisement does not have an entry in the local version of the link state database and sending a link state acknowledgement.
